(19) United States
(12) Patent Application Publication
(10) Pub. No.: US 2010/0188002 A1
(43) Pub. Date: Jul. 29, 2010

(54) OVERVOLTAGE PROTECTION FOR CURRENT LIMITING CIRCUITS IN LED APPLICATIONS

(75) Inventors: Ching-Yao Hung, Palatine, IL (US); Rama Venkatraman, Aurora, IL (US); Roman Korsunsky, Downington, PA (US); Joseph Gerard Renauer, Naperville, IL (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/360,728

(22) Filed: Jan. 27, 2009

(51) Int. Cl. H05B 37/00; H02H 7/00

(52) U.S. Cl. 315/122; 361/18

(57) ABSTRACT

An apparatus to provide overvoltage protection is shown. The apparatus comprises a boost converter (having an output node, a sensing network, and an impedance network) and a zener diode. The zener diode is coupled to the output node and to the sensing network. The breakdown value of the zener diode is selected to be greater than a desired voltage drop across a load when the load is coupled to the output node, and the zener diode creates an overcurrent fault in the boost converter when the voltage at the output node is greater than its breakdown value.

### CROSS-REFERENCE TO RELATED APPLICATIONS

This application is related to co-pending U.S. patent application Ser. No. ______, entitled “METHOD AND APPARATUS FOR CONTROLLING AND MODULATING LED CURRENT,” filed on ______, which is hereby incorporated by reference for all purposes.

### TECHNICAL FIELD

The invention relates generally to powering light emitting diodes (LEDs) and, more particularly, to a method and apparatus for dimming LEDs.

### BACKGROUND

Light emitting diodes (LEDs) are becoming increasingly common as light sources, replacing incandescent bulbs. As a result of the increasing usage of LEDs as light sources, there have been numerous developments in the power circuitry for LEDs. Some examples of power circuitry are PCT Pub. No. WO01/60127 and U.S. Pre-Grant Pub. No. 2007/0024213.

### SUMMARY

A preferred embodiment of the present invention, accordingly, provides an apparatus. The apparatus comprises an inductor having a first terminal and a second terminal, wherein the inductor receives an input voltage at its first terminal; a first diode coupled to the second terminal of the inductor; an impedance network, wherein at least a first portion of the impedance network is coupled to ground; a plurality of light emitting diodes (LEDs) coupled in series with one another, wherein the plurality of LEDs are coupled between the diode and the impedance network; a sensing network coupled to ground; a first switch coupled between the second terminal of the inductor and the sensing network; a controller coupled to the impedance network and the sensing network, wherein the controller is adapted to actuate the first switch; and a dimming circuit coupled to at least a second portion of the impedance network and to ground, wherein the dimming circuit is controlled by a signal for dimming the plurality of LEDs.

In accordance with an embodiment of the invention, the first portion of the impedance network further comprises a resistor network having at least one resistor coupled to ground.

In accordance with an embodiment of the invention, the second portion of the impedance network further comprises a feedback network that is coupled to the controller and to the dimming circuit.

In accordance with an embodiment of the invention, the sensing network further comprises a first resistor coupled between the first switch and ground; and a second resistor coupled to the controller and to the node between the first resistor and the first switch.

In accordance with an embodiment of the invention, the first switch further comprises an enhancement mode NMOS FET.

In accordance with an embodiment of the invention, the dimming circuit further comprises a second diode coupled to the second portion of the impedance network; a second switch coupled between the second diodes and ground, wherein the switch receives the signal for dimming the plurality of LEDs; and a network coupled to the controller and to the node between the second diode and the second switch.

In accordance with an embodiment of the invention, the second switch is an enhancement mode NMOS FET.

In accordance with an embodiment of the invention, the first diode is a Schottky diode.

In accordance with an embodiment of the invention, an apparatus is provided. The apparatus comprises a boost converter having an output node, a regulator node, a sensing network, and an impedance network; a plurality of LEDs coupled in series with one another, wherein a plurality of LEDs are coupled between the output node and the impedance network; and a dimming circuit coupled to the boost converter, wherein the dimming circuit includes a diode coupled to the impedance network; a switch coupled between the diodes and ground, wherein the switch receives the signal for dimming the plurality of LEDs; and a network coupled to the regulator node and to the node between the second diode and the second switch.

In accordance with an embodiment of the invention, the impedance network further comprises a resistor network having at least one resistor coupled to ground.

In accordance with an embodiment of the invention, the impedance network further comprises a feedback network that is coupled to the switch of the dimming circuit.

In accordance with an embodiment of the invention, the boost converter further comprises a FET.

In accordance with an embodiment of the invention, the FET is an enhancement mode NMOS FET.

In accordance with an embodiment of the invention, the sensing network further comprises a first resistor coupled between the FET and ground; and a second resistor coupled to the node between the first resistor and the FET.

In accordance with an embodiment of the invention, the boost converter further comprises a Schottky diode.

In accordance with an embodiment of the invention, an apparatus is provided. The apparatus comprises an inductor having a first terminal and a second terminal, wherein the inductor receives an input voltage at its first terminal; a first diode coupled to the second terminal of the inductor and to an output node; an impedance network, wherein at least a first portion of the impedance network is coupled to ground; a sensing network coupled to ground; a first switch coupled between the second terminal of the inductor and the sensing network; a controller coupled to the impedance network and the sensing network, wherein the controller is adapted to actuate the first switch; and a zener diode that is coupled to the output node and to the sensing network, wherein the breakdown value of the zener diode is selected to be greater than a desired voltage drop across a load when the load is coupled to the output node, and wherein the zener diode creates an overcurrent fault in the controller when the voltage at the output node is greater than its breakdown value.

In accordance with an embodiment of the invention, the apparatus further comprises a plurality of light emitting diodes (LEDs) coupled in series with one another, wherein the plurality of LEDs are coupled between the diode and the impedance network, and wherein the plurality of LEDs comprise the load.

In accordance with an embodiment of the invention, an apparatus is provided. The apparatus comprises a boost converter having an output node, a sensing network, and an impedance network; and a zener diode that is coupled to the output node and to the sensing network, wherein the breakdown value of the zener diode is selected to be greater than a desired voltage drop across a load when the load is coupled to the output node, and wherein the zener diode creates an overcurrent fault in the boost converter when the voltage at the output node is greater than its breakdown value.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a circuit in accordance with an embodiment of the invention; and

FIG. 2 is a graph depicting waveforms of the circuit of FIG. 1.

### DETAILED DESCRIPTION

Refer now to the drawings wherein depicted elements are, for the sake of clarity, not necessarily shown to scale and wherein like or similar elements are designated by the same reference numeral through the several views.

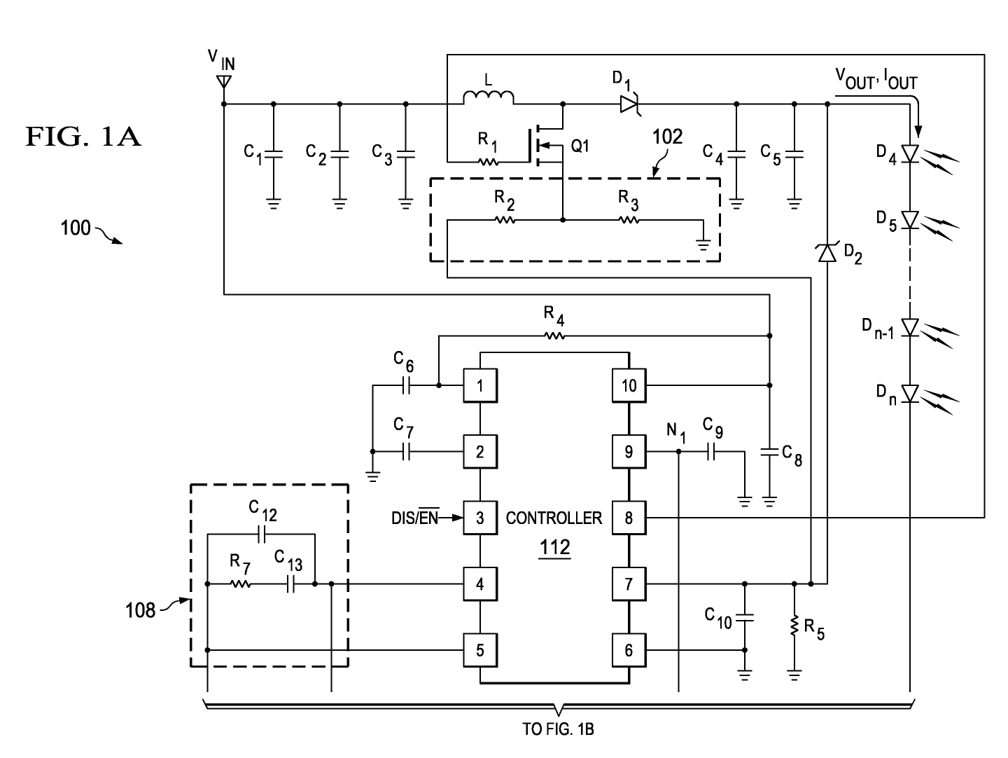

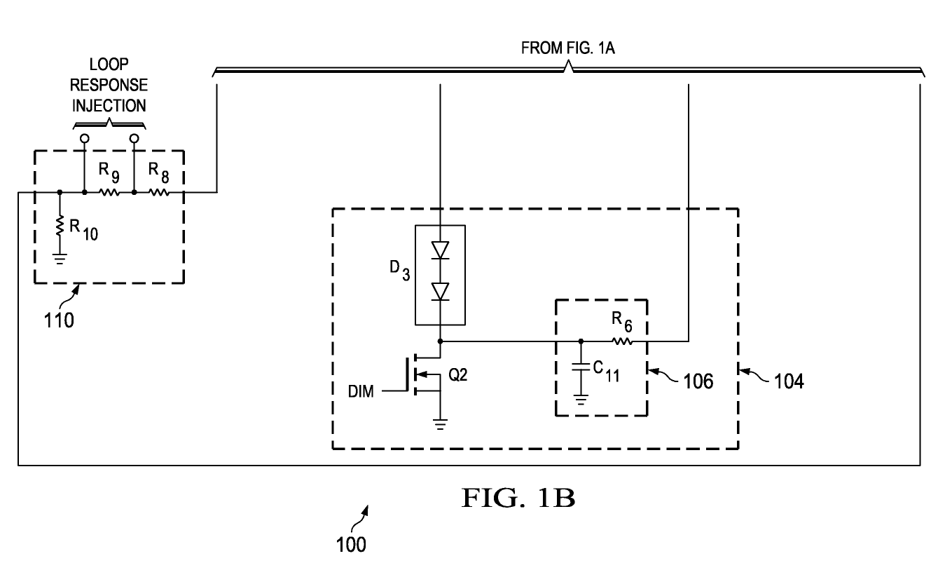

Referring to FIG. 1 of the drawings, the reference numeral 100 generally designates a circuit in accordance with an embodiment of the invention. Circuit 100 is generally a boost DC-DC converter for providing power to a plurality of LEDs D₄ to Dₙ (preferably 10 LEDs). The boost converter is generally comprised of controller 112, inductor L, diode D₁, capacitors C₁ through C₁₀, sensing network 102, resistors R₁, R₄, and R₅, resistor network 110, and feedback network 108.

In operation, the boost converter converts an input voltage V_{IN} into a higher output voltage V_{OUT}. Preferably, the input voltage V_{IN} is smoothed by capacitors C₁ through C₃ and input into the first terminal of the inductor L. A switch Q₁ (which is preferably an enhancement mode NMOS FET) and diode D₁ (which is preferably a Schottky diode) are coupled to the second terminal of the inductor L. Sensing network 102 is also connected to the switch Q₁, and, preferably, the switch Q₁ is coupled to the node between resistor R₂ (coupled to the controller 112) and resistor R₃ (coupled to ground). The switch Q₁ is controlled by controller 112, which allows the inductor to charge and discharge. Capacitors C₄ and C₅ are coupled to diode D₁ at an output node, which outputs the output voltage V_{OUT} and output current I_{OUT}. The output current I_{OUT} and output voltage V_{OUT} provide power to energize LEDs D₄ through Dₙ, which are coupled to the impedance network 108 and 110.

The impedance network 108 and 110 is generally used as part of a closed loop control system. Internal to the controller 112 is an error amplifier. One example of a controller that can be used for this application is the TPS40211 from Texas Instrument Incorporated. The error amplifier receives a voltage from the first portion of the impedance network or the resistor network 110. The resistor network 110 is generally comprised of resistors R₈, R₉, and R₁₀ that are used to sense the output current I_{OUT}. Coupled to the output of the resistor network 110 is the second portion of the impedance network or feedback network 108. The feedback network 108 is generally comprised of capacitors C₁₂ and C₁₃ and resistor R₇ that receive the output of the error amplifier COMP of the controller 112. The feedback network 108 can then provide a feedback signal to the resistor network 110 based on the output of the error amplifier COMP. This impedance network 108 and 110 can, thus, assist in regulating the output current I_{OUT}.

In addition to being able to simply provide power to LEDs D₄ through Dₙ, the circuit 100 has the capability of dimming the LEDs D₄ through Dₙ. A dimming circuit 104 is generally used to help dim the LEDs D₄ through Dₙ by effectively overriding the closed loop control of the output current I_{OUT}. To accomplish this, dimming circuit 104 interrupts the operation of the impedance network. The dimming circuit 104 is generally comprised of a network 106, a diode D3, and a switch Q₂. Diode D₃ is coupled to the output of the error amplifier COMP (which is also the input of the feedback network 108) and is coupled to the switch Q₂ (preferably an enhancement mode NMOS FET). Switch Q₂ is also coupled to ground and is controlled by a signal DIM for dimming the LEDs D₄ to Dₙ. Additionally, network 106 (which is generally comprised of capacitor C₁₁ and resistor R₆) is coupled to the node between diode D₃ and switch Q₂ and to a regulator node N₁ from controller 112.

Moreover, a zener diode D₂ is coupled between the output node and the feedback from the sensing network 102. Preferably, zener diode D₂ is employed to generally provide overvoltage protection. To accomplish this, the zener diode D₂ is selected to have a breakdown value that is greater than the voltage drop across a load, such as LEDs. For example, if 10 LEDs (each having about 3.3V drop) are employed as the load, the total voltage drop (account for temperature and other variation) will be about 35V, so the breakdown voltage for the zener diode D₂ would be selected to be about 40V. Once the output voltage is greater than the breakdown voltage (such as disconnecting the LEDs) and because of its connection to the sensing circuit or current sensing circuit 102, an overcurrent fault is created in controller 112, allowing the circuit to shut down and protect various elements from an overload. This overcurrent fault can then persist until it is “safe” to operate normally (such as when the LEDs are connected). By employing a zener diode D₂ instead of the tradition feedback through the error amplifier of the controller 112, parasitic signals in the control loop can be avoided. Additionally, because of the the overcurrent fault, zener diode D₂ generally does not experience high current loads (>1 A) for long periods of time (>500 ms), and inexpensive zener diode D₂ can be employed.

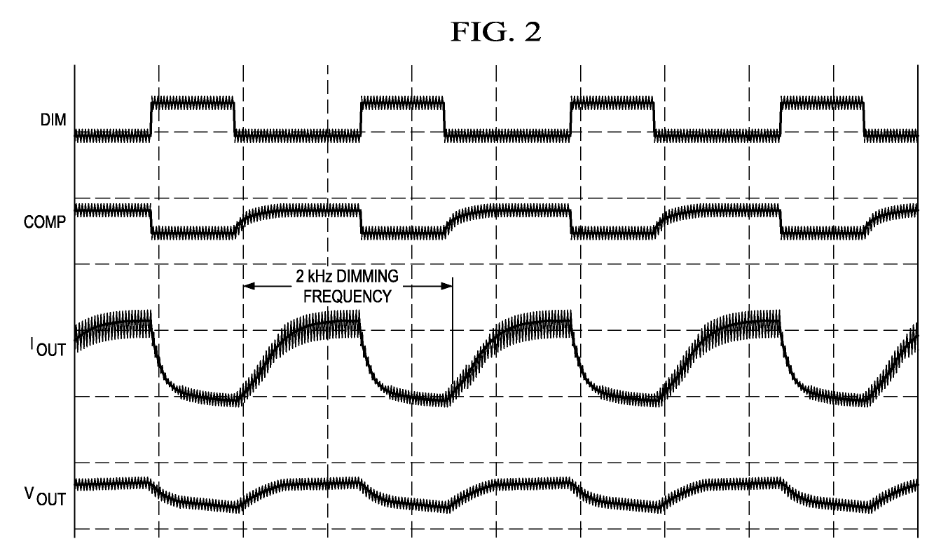

In FIG. 2, an example of the operation of over-voltage protection mechanisms, such as the over-voltage protection mechanism for circuit 100, can be seen. Preferably, the waveforms shown are measured at soft-start (from pin 2 of controller 112), sensed current (senses by resistor R₃), and the gate-drive signal (driving signal for transistor Q₁) of the controller 112 and V_{OUT}. As can be seen, the gate-drive signal stopped soon after sensed current level reaches the circuit limiter threshold of about 150 mV. The soft-start signal can then be started to be discharged to about zero before the circuit, such as circuit 100, would try to restart. If the over-voltage condition continues to be present, the sensed current signal will trigger the circuit limiter again and repeats the cycle, resulting an over-voltage protection characteristic.

During the normal operation, the switching current is sensed by resistor R₃ and is fed into the controller 112 through resistors R₂ and R₅, and capacitor C₁₀, where a conventional current loop is generally constructed. Should an over-voltage occur, with value set by diode D₂ at output node V_{OUT}, the sensed current level will be increased so as to exceed a current limiter threshold of the controller 112, and the gate-drive signal (which drives transistor Q₁) will be truncated. The output voltage V_{OUT} will cease to increase accordingly.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. An apparatus comprising:
an inductor having a first terminal and a second terminal, wherein the inductor receives an input voltage at its first terminal;
a first diode coupled to the second terminal of the inductor and to an output node;
an impedance network, wherein at least a first portion of the impedance network is coupled to ground;
a sensing network coupled to ground;
a first switch coupled between the second terminal of the inductor and the sensing network;
a controller coupled to the impedance network and the sensing network, wherein the controller is adapted to actuate the first switch; and
a zener diode that is coupled to the output node and to the sensing network, wherein the breakdown value of the zener diode is selected to be greater than a desired voltage drop across a load when the load is coupled to the output node, and wherein the zener diode creates an overcurrent fault in the controller when the voltage at the output node is greater than its breakdown value.

2. The apparatus of claim 1, wherein the first portion of the impedance network further comprises a resistor network having at least one resistor coupled to ground.

3. The apparatus of claim 1, wherein the second portion of the impedance network further comprises a feedback network that is coupled to the controller.

4. The apparatus of claim 1, wherein the sensing network further comprises:
a first resistor coupled between the first switch and ground; and
a second resistor coupled to the controller and to the node between the first resistor and the first switch.

5. The apparatus of claim 1, wherein the first switch further comprises an enhancement mode NMOS FET.

6. The apparatus of claim 1, wherein the apparatus further comprises a plurality of light emitting diodes (LEDs) coupled in series with one another, wherein the plurality of LEDs are coupled between the diode and the impedance network, and wherein the plurality of LEDs comprise the load.

7. The apparatus of claim 1, wherein the first diode is a Schottky diode.

8. An apparatus comprising:
a boost converter having an output node, a sensing network, and an impedance network; and
a zener diode that is coupled to the output node and to the sensing network, wherein the breakdown value of the zener diode is selected to be greater than a desired voltage drop across a load when the load is coupled to the output node, and wherein the zener diode creates an overcurrent fault in the boost converter when the voltage at the output node is greater than its breakdown value.

9. The apparatus of claim 8, wherein the first portion of the impedance network further comprises a resistor network having at least one resistor coupled to ground.

10. The apparatus of claim 8, wherein the second portion of the impedance network further comprises a feedback network that is coupled to the controller.

11. The apparatus of claim 8, wherein the sensing network further comprises:
a first resistor coupled between the first switch and ground; and
a second resistor coupled to the controller and to the node between the first resistor and the first switch.

12. The apparatus of claim 8, wherein the first switch further comprises an enhancement mode NMOS FET.

13. The apparatus of claim 8, wherein the apparatus further comprises a plurality of light emitting diodes (LEDs) coupled in series with one another, wherein the plurality of LEDs are coupled between the diode and the impedance network, and wherein the plurality of LEDs comprise the load.

14. The apparatus of claim 8, wherein the first diode is a Schottky diode.
